(19) United States
(12) Patent Application Publication
(10) Pub. No.: US 2023/0301417 A1
(43) Pub. Date: Sep. 28, 2023

(54) INTERACTIVE MAKEUP TUTORIAL SYSTEM AND METHOD THEREOF

(71) Applicant: Esteban Lopez, San Diego, CA (US)

(72) Inventor: Esteban Lopez, San Diego, CA (US)

(21) Appl. No.: 17/701,640

(22) Filed: Mar. 22, 2022

(51) Int. Cl. A45D 44/00; G06T 11/60; G06F 3/0486; G06F 3/0488

(52) U.S. Cl. CPC A45D 44/005; G06T 11/60; G06F 3/0486; G06F 3/0488; G06T 2200/24

(57) ABSTRACT

The present disclosure relates to an interactive makeup tutorial system and method thereof. In particular, the interactive makeup tutorial system may initiate face building editor, receive a first input from a user including a selected face type that best matches a face shape of the user; displaying the selected face shape to a workspace area, receive multiple inputs from the user including a face elements selected from a set of face elements presented by the face building editor to the user, generate a final face output onto the workspace area having makeup reference and application markers superimposed on the final face output, and generate a set of makeup instructional tutorials that is presented to the user, teaching them how to apply makeup based upon the instruction presented to the user.

### FIELD OF THE INVENTION

The present disclosure relates to an interactive makeup tutorial system and method thereof. In particular, the interactive makeup tutorial system encompasses a user-participation training system designed for non-professional makeup artists and ordinary users who desire to learn how to properly apply makeup by themselves via a face editor and makeup training instructions.

### BACKGROUND

The art of applying facial makeup spans several millennials and is present in almost every culture on earth. Despite its long history, learning how to apply facial makeup can often be a difficult task for most people who are new to cosmetics and are not familiar with proper makeup techniques for applying these cosmetics on the various facial elements (eyes, nose, cheeks, eyebrows, and so on). Although there are several makeup techniques, aids, books, videos, and instructional aids which teach the art of makeup, these techniques are often not practical and time consuming for those not quite familiar with makeup or just recently introduced to it.

More recently, automated makeup programs are now available and easily accessible for users, offering computer automated methods of applying facial makeup and cosmetics. For example, there are some makeup programs that are configured to take an image captured by a device (e.g., camera, scanner, or image digitization device), analyze the captured image, and then determine, based on face analytics, makeup areas which are then superimposed on the captured image. Though useful in some applications, this method often fails to teach the user subtle and proper techniques in the art of properly applying makeup, relying solely on face analytics determined and generated by the makeup program.

Another problem is that these types of makeup programs generally lack any participation from the user when determining or generating recommendations on where and how to apply facial makeup on the user's face.

Therefore, there is a need for a novel computer implemented makeup tutorial system allowing user participation, thereby engaging, guiding, and teaching them how to properly apply facial makeup through a visual interaction interface.

### SUMMARY

One object of this disclosure is to provide an interactive makeup tutorial system having a processor that executes instructions to: 1) initiate a face building editor having a workspace area, a face object container, and control buttons at a face building phase; 2) receive a first input from a user, where the first input comprises a face object selected by the user from a plurality of face shape objects disposed in the face object container, and where the face object matches a face shape of the user; 3) display the face object to the workspace area of the face building editor; receive a second input from the user including a first face element selected from a first set of face elements presented by the face building editor to the user; 4) receive a third input from the user including a second face element selected from a second set of face elements presented by the face building editor to the user; 5) receive a fourth input from the user including a third face element selected from a third set of face elements presented by the face building editor to the user; 6) receive a fifth input from the user including a fourth face element selected from a fourth set of face elements presented by the face building editor to the user; 7) receive a sixth input from the user including a fifth face element selected from a fifth set of face elements presented by the face building editor to the user; 8) generate a visual output onto the workspace area at a face makeup determination phase, where the visual output comprises a rendered face object having a plurality of makeup reference markers superimposed thereon; and 9) generate a set of makeup instructional tutorials that are presented to the user, teaching them how to apply makeup via a face building phase, a face makeup determination phase, and a makeup instructional tutorial phase at a makeup instructional tutorial phase.

In one embodiment, the first set of face elements may include a plurality of face shapes, such as a round shaped face, a square shaped face, an oval shaped face, a heart shaped face, an inverted triangle shaped face, an oblong shaped face, and a triangle shaped face.

In another embodiment, the first set of face elements comprises a plurality of eyes.

In another embodiment, the second set of face elements comprises a plurality of eyebrows.

In another embodiment, the third set of face elements comprises a plurality of noses.

In another embodiment, the fourth set of face elements comprises a plurality of lips.

In another embodiment, the fifth set of face elements comprises a plurality of wrinkles.

These and other objects, features and advantages of the present disclosure will become more apparent in light of the following detailed description of preferred embodiments thereof, as illustrated in the accompanying drawings.

### BRIEF DESCRIPTION OF THE DRAWINGS

Although the characteristic features of the present disclosure will be particularly pointed out in the claims, the invention itself and manner in which it may be made and used may be better understood after a review of the following description, taken in connection with the accompanying drawings wherein like numeral annotations are provided throughout.

FIG. 1 illustrates components of the interactive makeup tutorial system, in accordance with an embodiment of the present disclosure.

FIG. 2 illustrates a face editor application having blank workspace area displayed to the user at an initial step of the face building phase, in accordance to an embodiment.

FIG. 3 illustrates another step of the face building phase of the interactive makeup tutorial system, in accordance to an embodiment.

FIG. 4 illustrates another step of the face building phase of the interactive makeup tutorial system, in accordance to an embodiment.

FIG. 5 illustrates yet another step of the face building phase of the interactive makeup tutorial system, in accordance to an embodiment.

FIG. 6 illustrates yet another step of the face building phase of the interactive makeup tutorial system, in accordance to an embodiment.

FIG. 7 illustrates yet another step of the face building phase of the interactive makeup tutorial system, in accordance to an embodiment.

FIG. 8 illustrates still yet another step of the face building phase of the interactive makeup tutorial system, in accordance to an embodiment.

FIG. 9 illustrates a final step of the face building phase of the interactive makeup tutorial system, in accordance to an embodiment.

FIG. 10 illustrates the face makeup determination phase of the interactive makeup tutorial system, in accordance to an embodiment.

FIG. 11 illustrates the makeup instructional tutorial phase of the interactive makeup tutorial system, in accordance to an embodiment.

FIG. 12 illustrates recommended cosmetic products, applicators, liners, and brushes conveyed by the interactive makeup tutorial system, in accordance to an embodiment.

FIG. 13 illustrates the various face shape objects available to the interactive makeup tutorial system, in accordance to an embodiment.

FIG. 14 illustrates facial feature objects available to the interactive makeup tutorial system, in accordance to an embodiment.

FIG. 15 illustrates wrinkle objects available to the interactive makeup tutorial system, in accordance to an embodiment.

FIG. 16 illustrates another set of wrinkle objects available to the interactive makeup tutorial system, in accordance to an embodiment.

FIG. 17 illustrates yet another set of wrinkle objects available to the interactive makeup tutorial system, in accordance to an embodiment.

FIG. 18 illustrates a makeup tutorial flowchart of the interactive makeup tutorial system, in accordance to an embodiment.

FIG. 19 illustrates a computing block diagram of the computing device in which the interactive makeup tutorial system operates and executes instructions therein, in accordance to an embodiment.

FIG. 20 illustrates system block architecture of the interactive makeup tutorial system, in accordance to an embodiment.

### DETAILED DESCRIPTION

In general, the interactive makeup tutorial system 100 encompasses a user-participation training system designed for non-professional makeup artists and ordinary users who desire to learn how to apply makeup by themselves via a face editor and makeup training instructions. Advantageously, this interactive makeup tutorial system offers users the ability to “build a face” that closely resembles the “shape” and facial features of their own face, without the need or use of image capturing devices such as a camera or digital scanning device. Another advantage of face building application “app” and interactive makeup tutorial system 100 includes an integrated face makeup determination phase which determines optimal facial sites where makeup should be applied onto the face and corresponding shading intensities at these sites. Still, another advantage of the interactive makeup tutorial system 100 is a makeup instructional tutorial phase generated by the computing device 10 by which the user is provided training instructions on how and where to apply makeup based upon result generated in the face makeup determination phase.

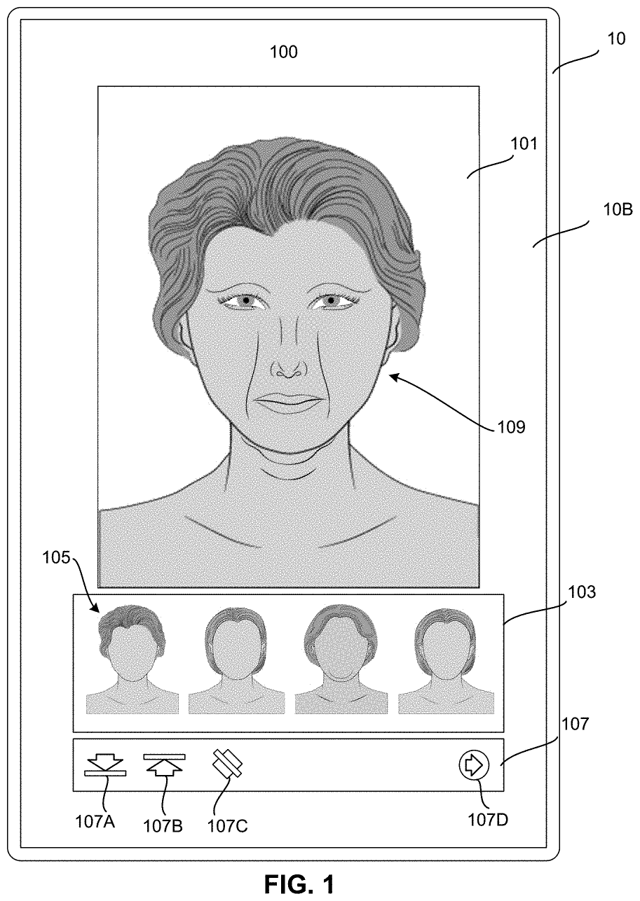

FIG. 1 illustrates components of the interactive makeup tutorial system 100, in accordance with an embodiment of the present disclosure. The interactive makeup tutorial system 100 may include a set of executable instructions for controlling and displaying facial elements, makeup related instructions, and other graphical and textual information to a user via a computing device 10. The computing device 10 may include any type of mobile computing or computer devices such as laptops, tablets, smartphones, mobile phones, personal digital assistants (PDAs) or other similar types of computing devices. In addition, the computing device 10 includes a display screen 103 having in input device such as a capacitive touchscreen interface for allowing the user to swipe, drag-and-drop objects, and provide user input to the device 101 via the touchscreen and finger of the user.

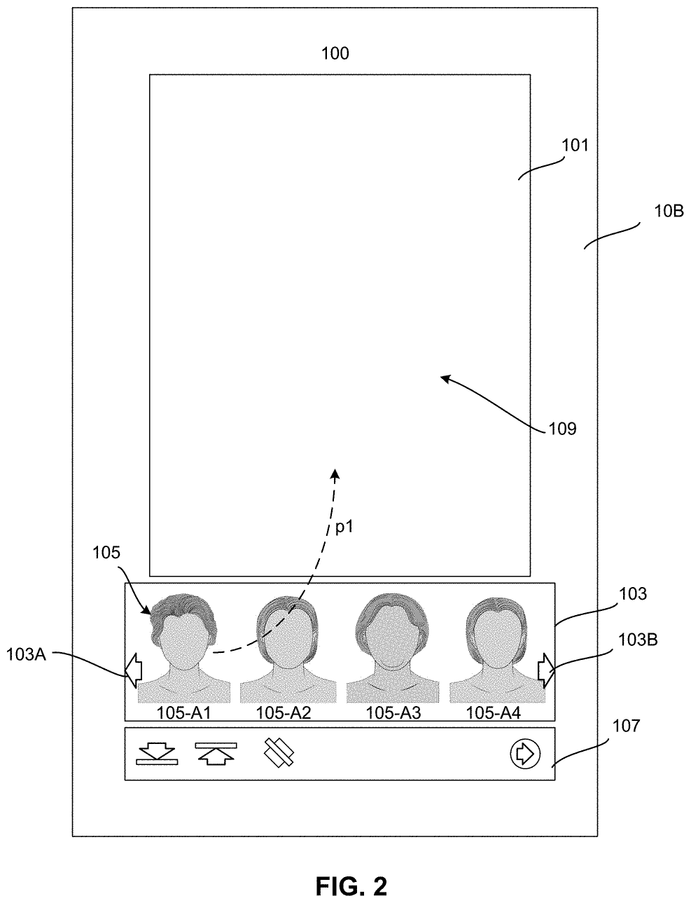

The interactive makeup tutorial system 100 has three phases: 1) a face building phase using a face editor; 2) a face makeup determination phase executed by computing device 10; and 3) a makeup instructional tutorial phase generated by the computing device 10. In the face building phase, users are presented with the face editor having a workspace and display elements to construct a facsimile of their face, including: 1) a face building workspace area 101; 2) a face object container 103 having one or more face objects 105; and 3) a control container 107 having user control buttons (107A-D). The user control buttons (107A-D) of the face editor allow the user to manipulate the objects in the workspace area 101. For example, a save or download button 107A is provided which allows the user the ability to save or download objects and images from the workspace area 101 to their device 10; a share button 107B is provided which allows the user the ability to share objects and images that a user has prepared or designed in the workspace area 101 with other users; a erase or clear button 107C is provided which allows the user to clear the workspace area 101 of all objects and images; and a face render button 107D is provided which allows the user to render the final face image after implementing or designing the final face with all user desired face elements applied thereon. In operation, the face building workspace area 101 may receive one or more selected face elements which are placed onto the workspace area 101 by the user via drag-and-drop control, allowing the user to easily build a face 109 closely resembling and matching their own face and facial features. The face building phase, steps, and elements therein are further illustrated in FIG. 2-FIG. 8 and described in detail in the following sections.

FIG. 2 illustrates the face editor application having blank workspace area 101 displayed to the user at an initial step of the face building phase, in accordance to an embodiment. Prior to building the face, the user is presented with one or more face objects 105 in the face object container 103 from which the user may select. Initially, these face objects 105 include multiple faces of different shapes such as, for example, round 105-A1, square 105-A2, oval 105-A3, and heart 105-A4 face shape objects. Additional face objects 105 which do not appear in the face object container 103 can be viewed by the user by swiping the container area displayed on the touchscreen 10B using a left or right finger gesture or depressing the left and right control buttons (103A, 103B) accordingly. To build a face using the face editor application, the user may select one of the face objects 105-A1 by depressing the selected face and dragging it (along path p1) onto the workspace area 101. In addition, the selected face 105-A1 may be proportionally resized to any size by the user. Resizing may be accomplished using a pinch-to-resize action having a multi-touch gesture that allows the user to increase or decrease the size of the selected face 105-A1 on the touchscreen 10B. To use pinch-to-resize, the user touches two fingers on the touchscreen 10B of the selected face 105-A1, and moves them apart to increase the size, or together to decrease the size. Furthermore, the selected face 105-A1 may be rotated by the user by applying a rotation gesture on the touchscreen. For example, the rotation gesture is recognized via a rotate touch handler that is optimized to detect one finger rotation gestures.

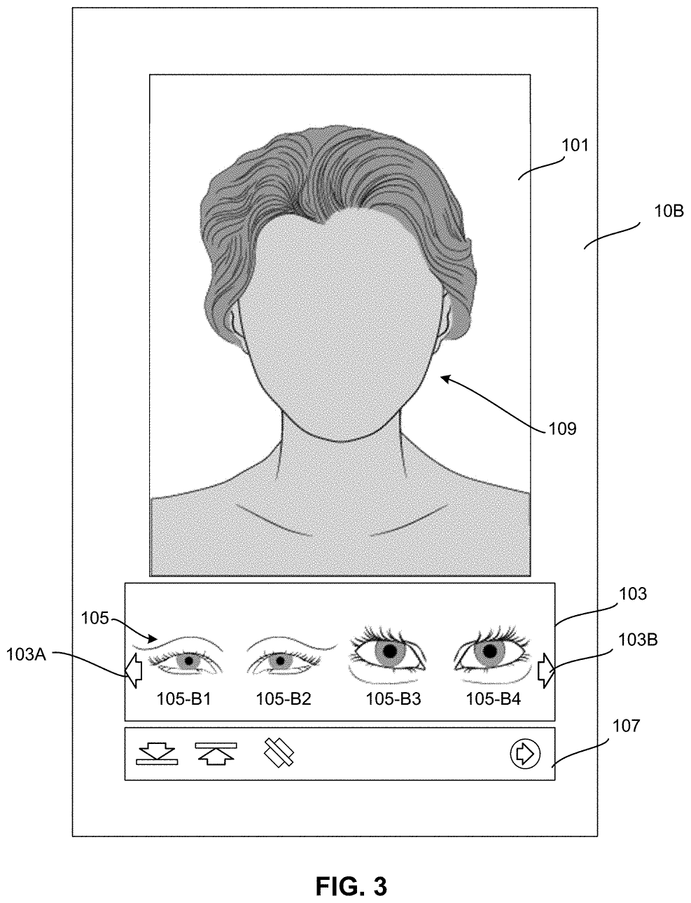

FIG. 3 illustrates another step of the face building phase of the interactive makeup tutorial system 100, in accordance to an embodiment. At this step, the face object 105-A1 selected by the user now appears in the workspace area 101, while another set of face objects 105 are then presented in face object container 103 including, for example, a set of left and right eyes (105-B1, 105-B2, 105-B3, 105-B4) of varying shapes and styles. Additional face objects 105 of eyes which do not appear in the face object container 103 can be viewed by the user by swiping the container area displayed on the touchscreen 10B using a left or right finger gesture or depressing the left and right control buttons (103A, 103B) accordingly.

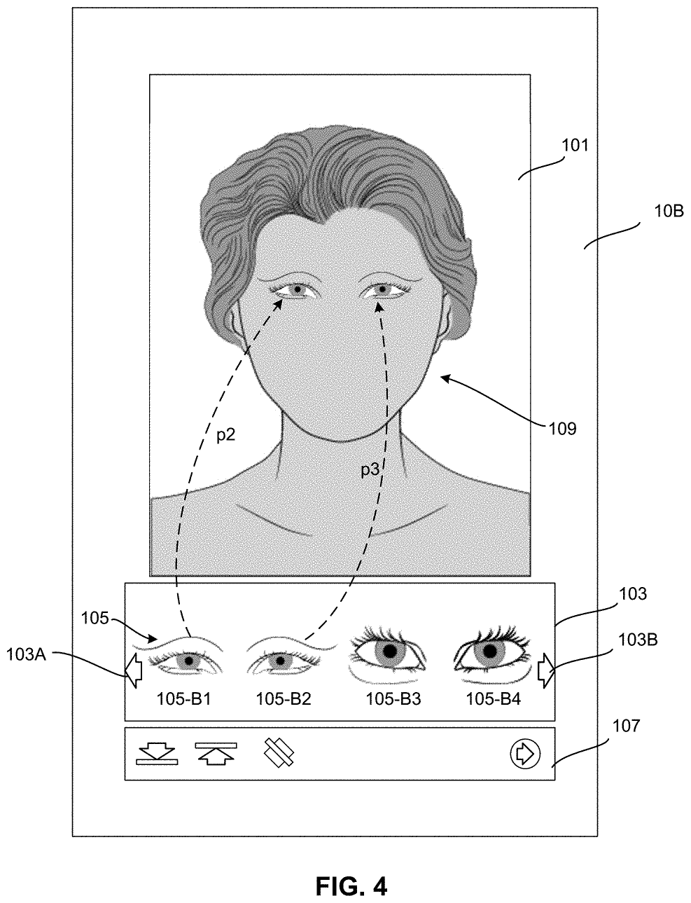

FIG. 4 illustrates another step of the face building phase of the interactive makeup tutorial system 100, in accordance to an embodiment. At this step, the face object 105-A1 selected by the user now appears in the workspace area 101, while another set of face objects 105 are then presented in face object container 103 including, for example, left and right eyes (105-B1, 105-B2, 105-B3, 105-B4) of varying shapes and styles. Additional face objects 105 of eyes which do not appear in the face object container 103 can be viewed by the user by swiping the container area displayed on the touchscreen 10B using a left or right finger gesture or depressing the left and right control buttons (103A, 103B) accordingly. To continue building the face, the user may select a left eye and a right eye (105-B1, 105-B2) by depressing each eye and dragging it by using an upward finger gesture (along paths p2 and p3) onto the workspace area 101. In addition, the each eye (105-B1, 105-B2) may be proportionally resized to any size by the user. Resizing may be accomplished using a pinch-to-resize action having a multi-touch gesture that allows the user to increase or decrease the size of each eye on the touchscreen 10B. To use pinch-to-resize, the user touches two fingers on the touchscreen 10B of the selected eye (105-B1 or 105-B2), and moves them apart to increase the size, or together to decrease the size. Furthermore, each eye (105-B1, 105-B2) may be rotated by the user by applying the rotation gesture on the touchscreen.

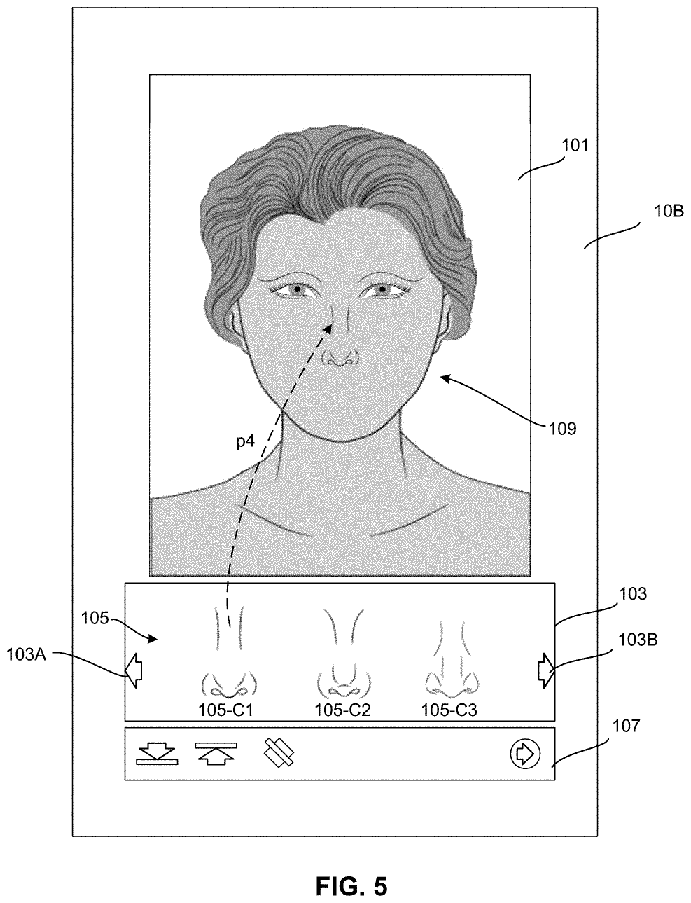

FIG. 5 illustrates yet another step of the face building phase of the interactive makeup tutorial system 100, in accordance to an embodiment. At this step, another set of face objects 105 are then presented in face object container 103 including, for example, noses (105-C1, 105-C2, 105-C3) of varying shapes and styles. If additional face objects 105 of noses are available and do not appear in the face object container 103, they can be viewed by the user by swiping the container area displayed on the touchscreen using a left or right finger gesture or depressing the left and right control buttons (103A, 103B) accordingly. To continue building the face, the user may select a nose (105-C1) by depressing it on the touchscreen 10B and dragging it by using an upward finger gesture (along path p4) onto the workspace area 101. In addition, the nose (105-C1) may be proportionally resized to any size by the user. Resizing may be accomplished using a pinch-to-resize action having a multi-touch gesture that allows the user to increase or decrease the size of the nose on the touchscreen 10B. To use pinch-to-resize, the user touches two fingers on the touchscreen 10B of the selected nose 105-C1, and moves them apart to increase the size, or together to decrease the size. Moreover, the nose (105-C1) may be rotated by the user by applying the rotation gesture on the touchscreen.

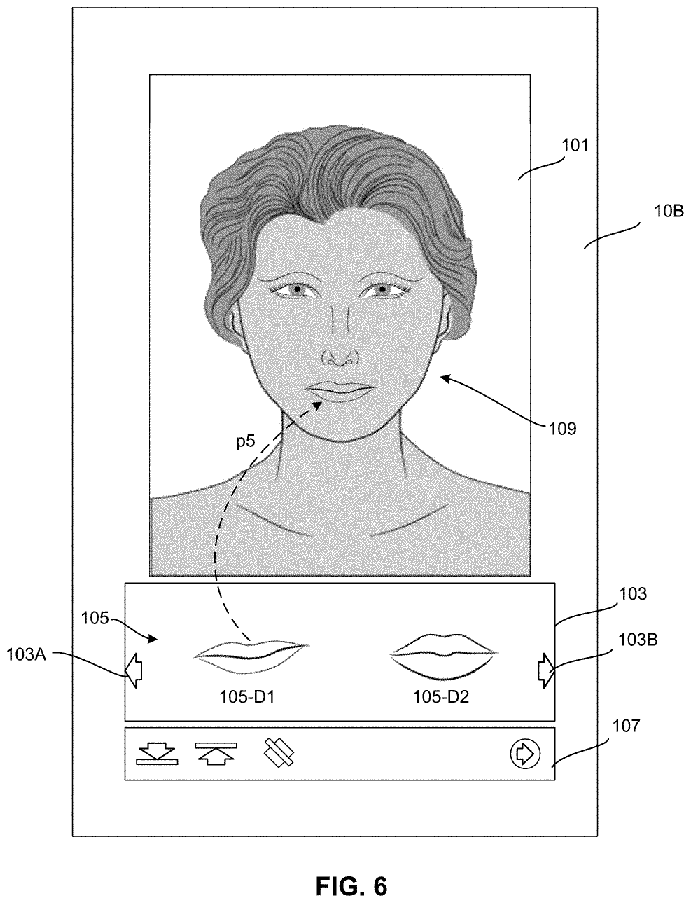

FIG. 6 illustrates yet another step of the face building phase of the interactive makeup tutorial system 100, in accordance to an embodiment. At this step, another set of face objects 105 are then presented in face object container 103 including, for example, lips (105-D1, 105-D2) of varying shapes and styles. If additional face objects 105 of lips are available and do not appear in the face object container 103, they can be viewed by the user by swiping the container area displayed on the touchscreen using a left or right finger gesture or depressing the left and right control buttons (103A, 103B) accordingly. To continue building the face, the user may select a pair lips (105-D1) by depressing it on the touchscreen 10B and dragging it by using an upward finger gesture (along path p5) onto the workspace area 101. In addition, the pair lips (105-D1) may be proportionally resized to any size by the user. Resizing may be accomplished using a pinch-to-resize action having a multi-touch gesture that allows the user to increase or decrease the size of the lips on the touchscreen 10B. To use pinch-to-resize, the user touches two fingers on the touchscreen 10B of the selected pair lips (105-D1), and moves them apart to increase the size, or together to decrease the size. Additionally, the pair lips (105-D1) may be rotated by the user by applying the rotation gesture on the touchscreen.

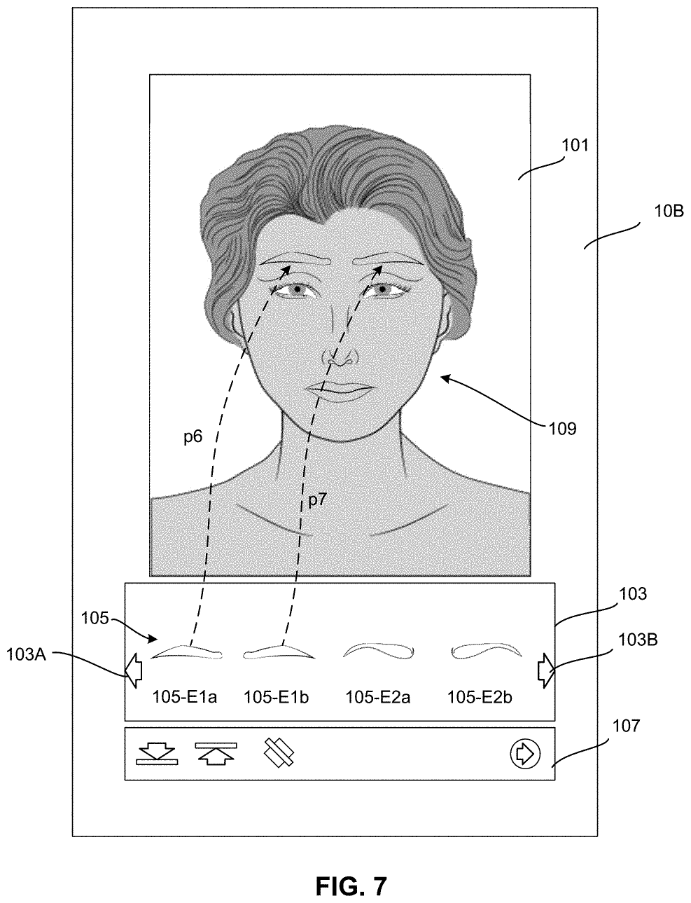

FIG. 7 illustrates yet another step of the face building phase of the interactive makeup tutorial system 100, in accordance to an embodiment. At this step, another set of face objects 105 are then presented in face object container 103 including, for example, eyebrows (105-E1a, 105-E1b, 105-E2a, 105-E2b) of varying shapes and styles. Additional face objects 105 of eyebrows which do not appear in the face object container 103 can be viewed by the user by swiping the container area displayed on the touchscreen 10B using a left or right finger gesture or depressing the left and right control buttons (103A, 103B) accordingly. To continue building the face, the user may select a left eyebrow and a right eyebrow (105-E1a, 105-E1b) by depressing each eyebrow and dragging it by using an upward finger gesture (along paths p6 and p7) onto the workspace area 101. In addition, the each eyebrow (105-E1a, 105-E1b) may be proportionally resized to any size by the user. Resizing may be accomplished using a pinch-to-resize action having a multi-touch gesture that allows the user to increase or decrease the size of each eyebrow on the touchscreen 10B. To use pinch-to-resize, the user touches two fingers on the touchscreen 10B of the selected eyebrow, and moves them apart to increase the size, or together to decrease the size. Furthermore, each eyebrow (105-E1a, 105-E1b) may be rotated by the user by applying the rotation gesture on the touchscreen.

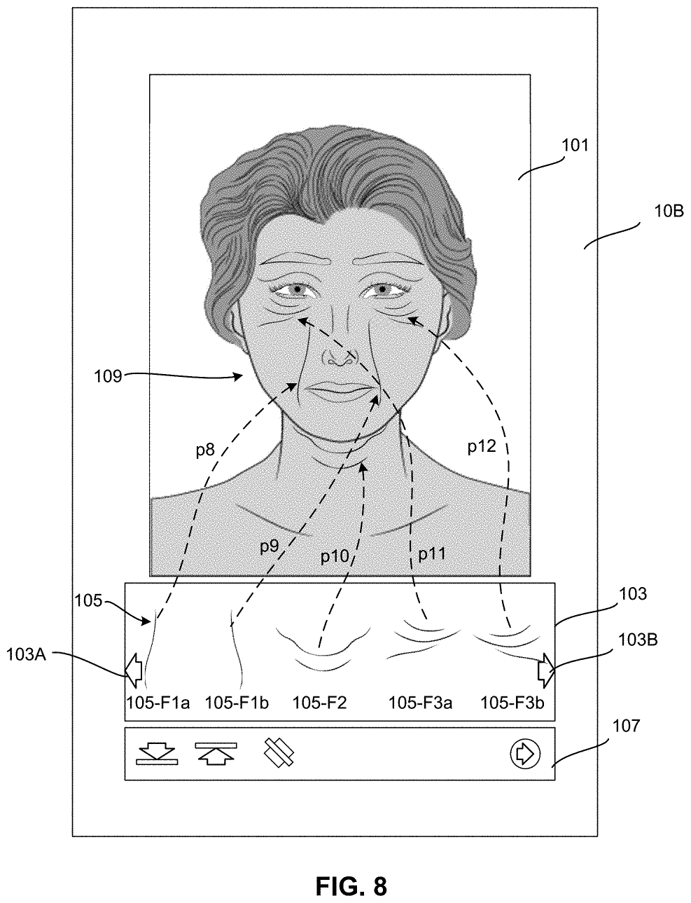

FIG. 8 illustrates still yet another step of the face building phase of the interactive makeup tutorial system 100, in accordance to an embodiment. At this step, another set of face objects 105 are then presented in face object container 103 including, for example, wrinkles (105-F1a, 105-F1b, 105-F2, 105-F3a, 105-F3b) of varying degrees, shapes and styles. Additional face objects 105 of wrinkles which do not appear in the face object container 103 can be viewed by the user by swiping the container area displayed on the touchscreen 10B using a left or right finger gesture or depressing the left and right control buttons (103A, 103B) accordingly. At this stage of the face building phase, the user may add multiple types of wrinkles to face 109, including but not limited to cheek wrinkles, double-chins, lip corner wrinkles, etc. For example, to continue building the face with wrinkles, the user may select a set of cheek wrinkles (105-F1a, 105-F1b) by depressing each cheek wrinkle on the touchscreen 10B and dragging it by using an upward finger gesture (along paths p8 and p9) onto the workspace area 101. A double-chin wrinkle (105-F2) may be applied to the face 109 by depressing the double-chin wrinkle (105-F2) on the touchscreen 10B and dragging it by using an upward finger gesture (along path p10) onto the workspace area 101. The user may further opt to select a set of eye wrinkles (105-F3a, 105-F3b) by depressing each eye wrinkle on the touchscreen 10B and dragging it by using an upward finger gesture (along paths p11 and p12S) onto the workspace area 101. Moreover, each wrinkle object (105-F1a, 105-F1b, 105-F2, 105-F3a, 105-F3b) may be proportionally resized to any size by the user. Resizing may be accomplished using a pinch-to-resize action having a multi-touch gesture that allows the user to increase or decrease the size of the wrinkle object on the touchscreen 10B. To use pinch-to-resize, the user touches two fingers on the touchscreen 10B of the selected wrinkle object, and moves them apart to increase the size, or together to decrease the size. Additionally, each wrinkle object (105-F1a, 105-F1b, 105-F2, 105-F3a, 105-F3b) may be rotated by the user by applying the rotation gesture on the touchscreen.

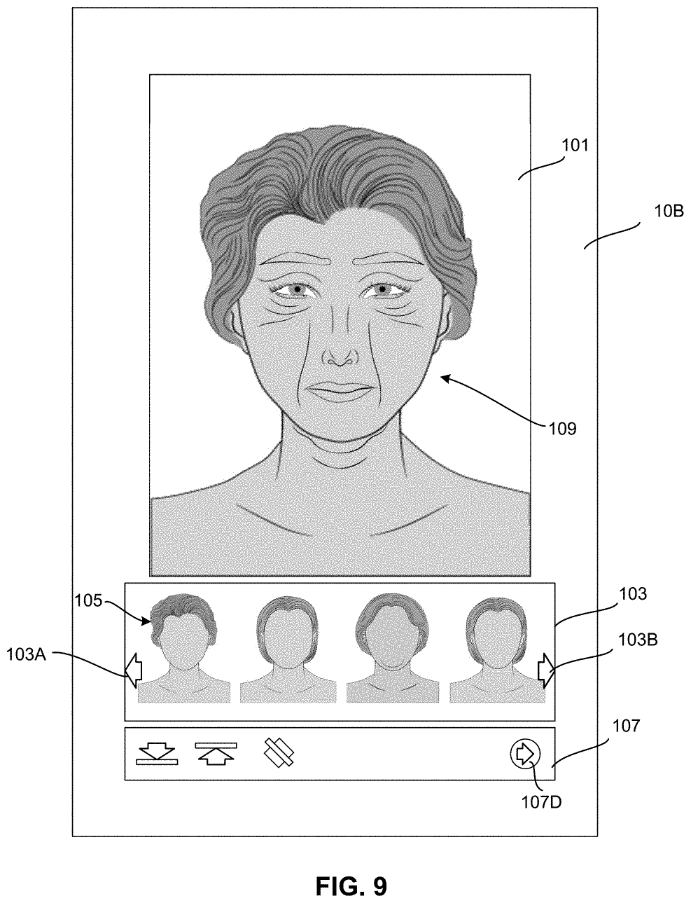

FIG. 9 illustrates a final step of the face building phase of the interactive makeup tutorial system 100, in accordance to an embodiment. In the final step of the face building phase, a final face 109 with applied face objects (face shape, eyes, nose, lips, and wrinkles) defined by the user are displayed in the workspace area 101. Based on the appearance of the final face 109, the user may either accept or edit any of facial objects before continuing to the next phase. For example, editing face objects may be accomplished by clicking and dragging face objects (using the finger to click-and-drag objects via sliding the finger on the touchscreen 10B) from the workspace area 101 back to the face object container 103. Subsequently, new face objects may be applied to the face 109 as described in the previous sections presented above. At the final step of the face building phase, a generate face render button 107D is activated and enabled for the user to depress and continue to the next phase. Once the generate face render button 107D is activated and the user opts to accept the final face 109, the user may continue to the next phase by depressing the button 107D.

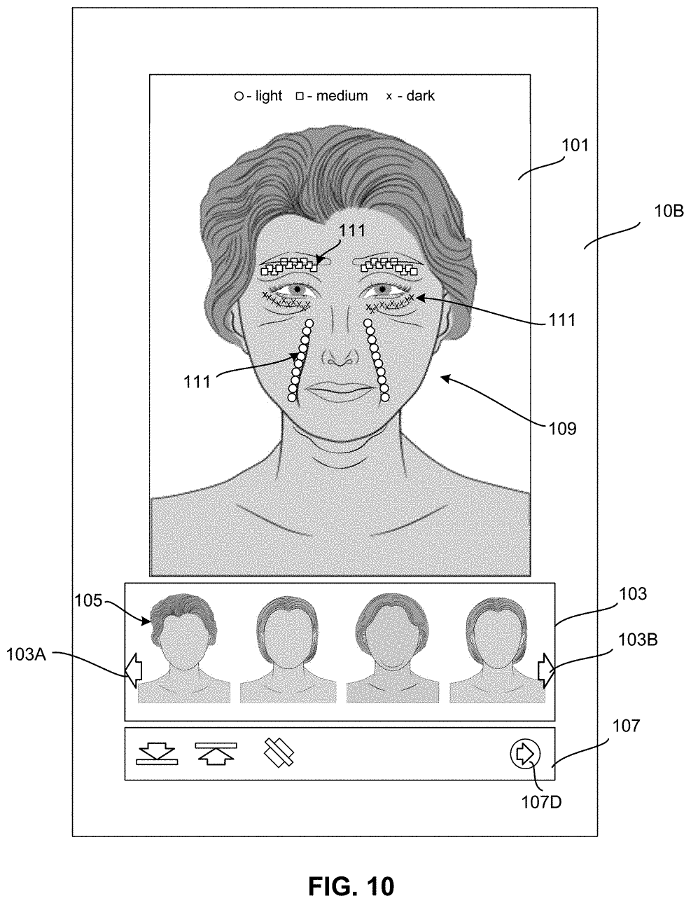

FIG. 10 illustrates the face makeup determination phase of the interactive makeup tutorial system 100, in accordance to an embodiment. After completion of the face building phase, the interactive makeup tutorial system 100 initiates a face makeup algorithm executed by the computing device 10. The face makeup algorithm determines optimal facial sites where makeup should be applied onto the final face 109 and corresponding shading intensities at these sites. In addition, the face makeup algorithm may generate a graphical overlay of icons 111 representing the shading intensity at different areas of the face 109. These icons may include but is not limited to reference objects such as circles, squares, and x's which represent light shading, medium shading, and dark shading, respectively.

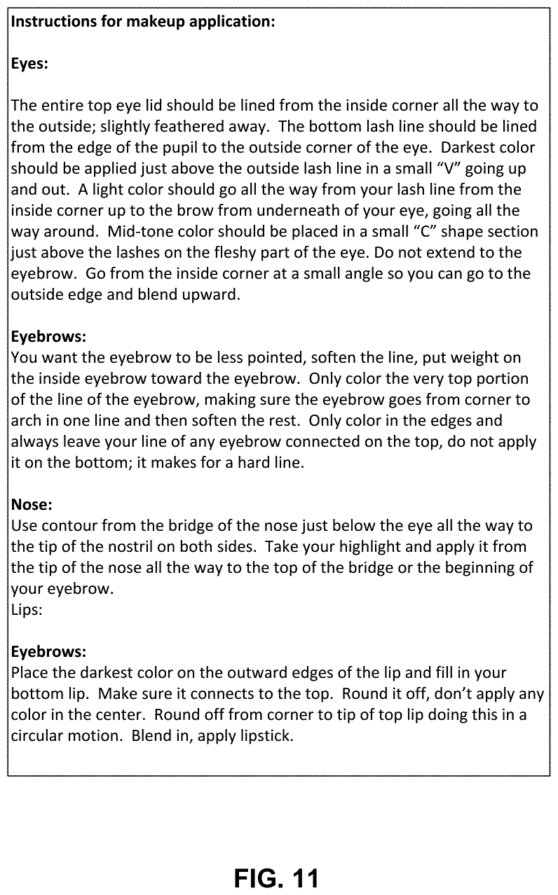

FIG. 11 illustrates the makeup instructional tutorial phase of the interactive makeup tutorial system 100, in accordance to an embodiment. In addition the visual presentation of the graphical overlay of icons 111 generated in the face makeup determination phase, the interactive makeup tutorial system 100 generates makeup instructional tutorial corresponding to the graphical overlay of icons 111 on the face 109. For example, some of these instructions may include but are not limited to makeup application instructions for the final face 109 as described below:

1) Makeup Instructions for the Eyes:

The entire top eye lid should be lined from the inside corner all the way to the outside; slightly feathered away. The bottom lash line should be lined from the edge of the pupil to the outside corner of the eye. Darkest color should be applied just above the outside lash line in a small “V” going up and out. A light color should go all the way from your lash line from the inside corner up to the brow from underneath of your eye, going all the way around. Mid-tone color should be placed in a small “C” shape section just above the lashes on the fleshy part of the eye. Do not extend to the eyebrow. Go from the inside corner at a small angle so you can go to the outside edge and blend upward.

2) Makeup Instructions for the Eyebrows:

You want the eyebrow to be less pointed, soften the line, put weight on the inside eyebrow toward the eyebrow. Only color the very top portion of the line of the eyebrow, making sure the eyebrow goes from corner to arch in one line and then soften the rest. Only color in the edges and always leave your line of any eyebrow connected on the top, do not apply it on the bottom; it makes for a hard line.

3) Makeup Instructions for the Nose:

Use contour from the bridge of the nose just below the eye all the way to the tip of the nostril on both sides. Take your highlight and apply it from the tip of the nose all the way to the top of the bridge or the beginning of your eyebrow.

4) Makeup Instructions for the Lips:

Place the darkest color on the outward edges of the lip and fill in your bottom lip. Make sure it connects to the top. Round it off, don't apply any color in the center. Round off from corner to tip of top lip doing this in a circular motion. Blend in, apply lipstick.

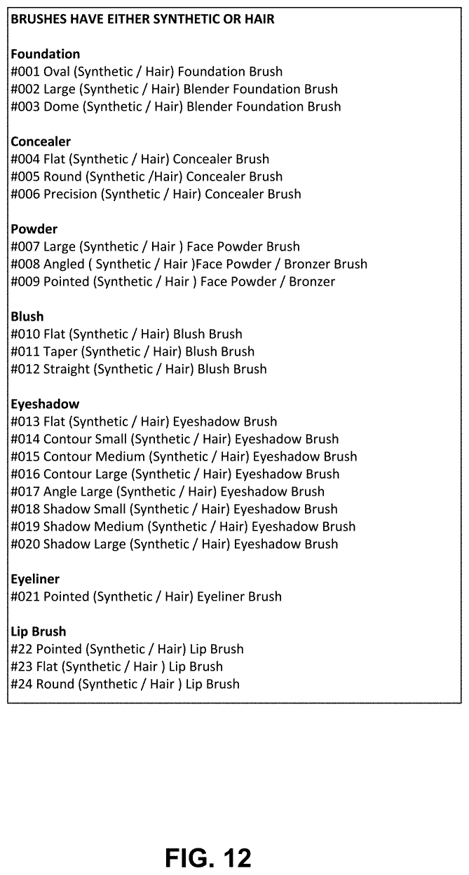

FIG. 12 illustrates predefined cosmetic products, applicators, liners, and brushes recommended to the user during the instructional tutorial phase by interactive makeup tutorial system 100, in accordance to an embodiment. The makeup application instructions generated by the interactive makeup tutorial system 100 may include predefined cosmetic products that correspond to the graphical overlay of icons 111 generated during the face makeup determination phase. For example, the interactive makeup tutorial system 100 may recommend, via the instructional tutorial phase, a #014 Contour Small (Synthetic/Hair) Eyeshadow for the medium shaded areas (square icons), #005 Round (Synthetic/Hair) Concealer Brush for the light shaded areas (circle icons), and #002 Large (Synthetic/Hair) Blender Foundation Brush for the dark shaded areas (x-icons).

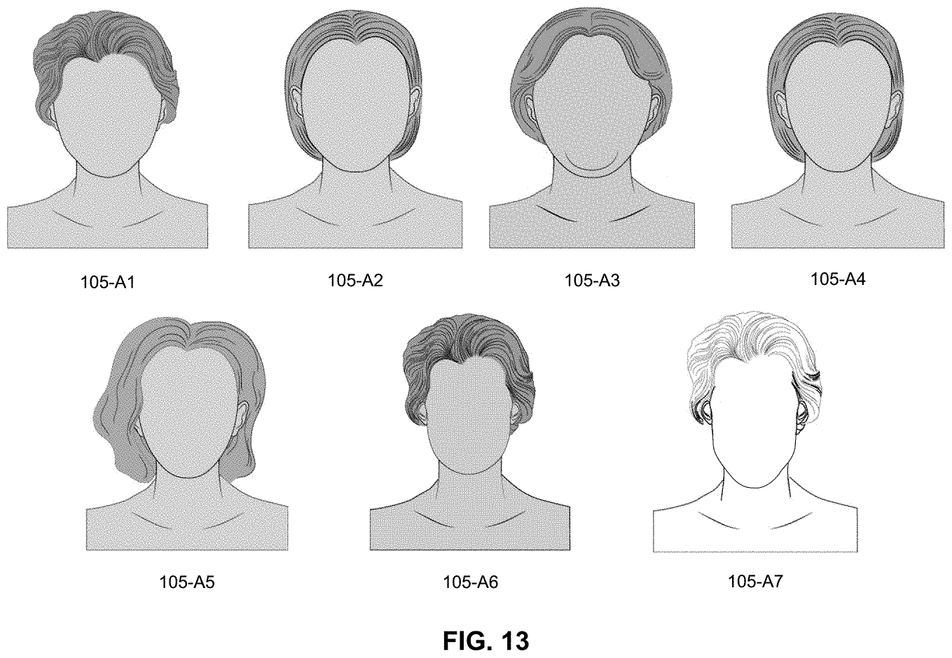

FIG. 13 illustrates the various face shape objects available to the interactive makeup tutorial system 100, in accordance to an embodiment. These face shape objects may include digital images, formatted in PNG, JPEG, GIF, BMP, TIFF, or any other types of digital image format, of universally known face shapes including but not limited to a round shaped face 105-A1, square shaped face 105-A2, oval shaped face 105-A3, heart shaped face 105-A4, inverted triangle shaped face 105-A5, oblong shaped face 105-A6, and triangle shaped face 105-A7. Images of these face shape objects may be stored in a database either locally on the computer device 10 or on a remote server and accessed and loaded into the face object container 103 by the face building app during the face building phase.

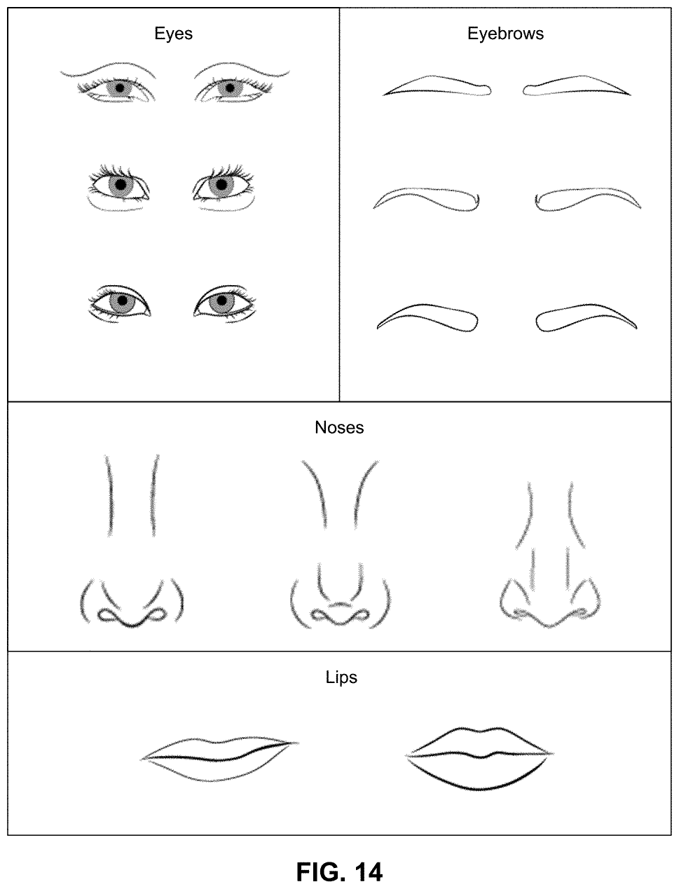

FIG. 14 illustrates facial feature objects available to the interactive makeup tutorial system 100, in accordance to an embodiment. These face objects may include digital images, formatted in PNG, JPEG, GIF, BMP, TIFF, or any other types of digital image format, of facial features including but not limited to eyes, eyebrows, noses, cheeks, and lips. These facial feature objects may be stored in a database either locally on the computer device 10 or on a remote server and accessed and loaded into the face object container 103 by the face building app during the face building phase.

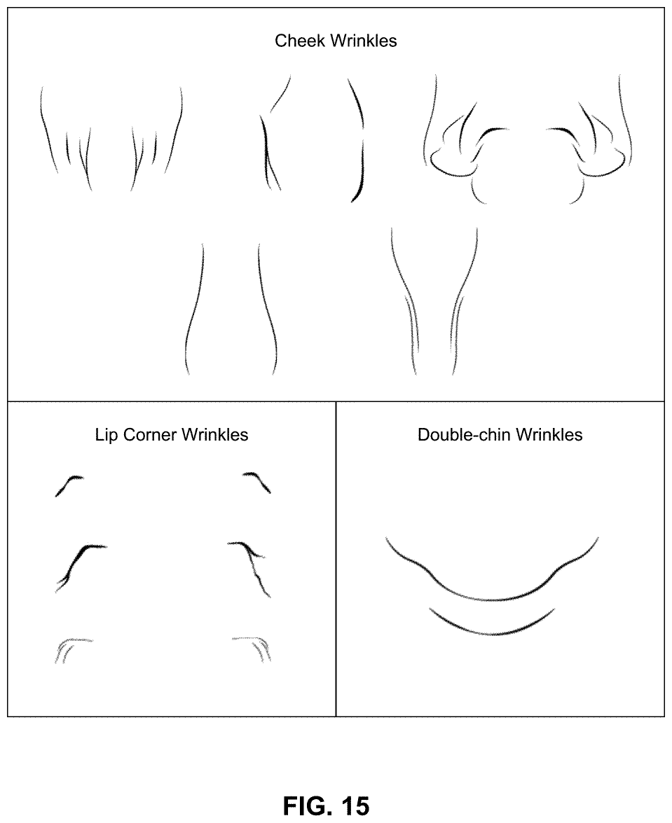

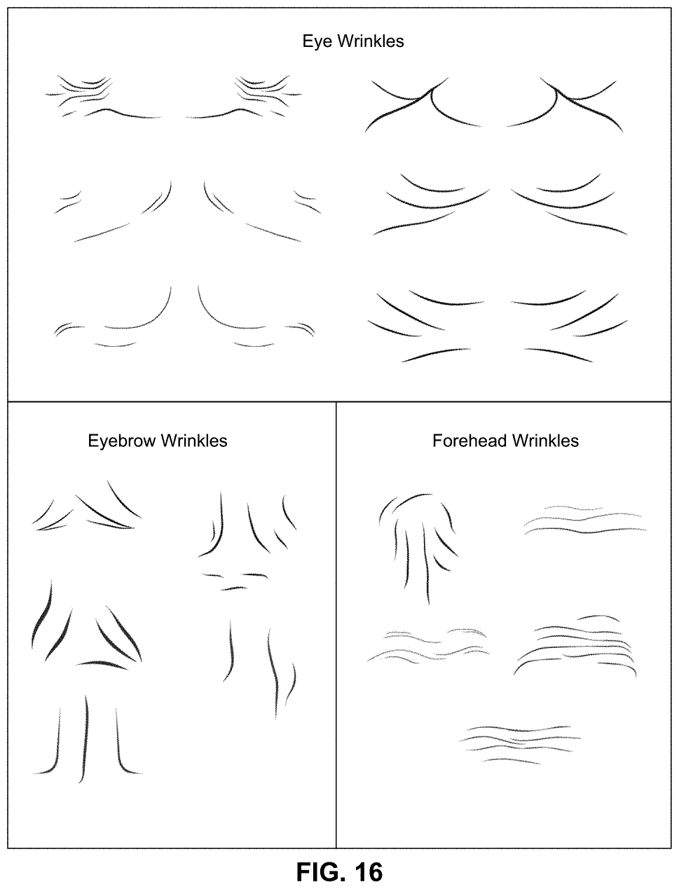

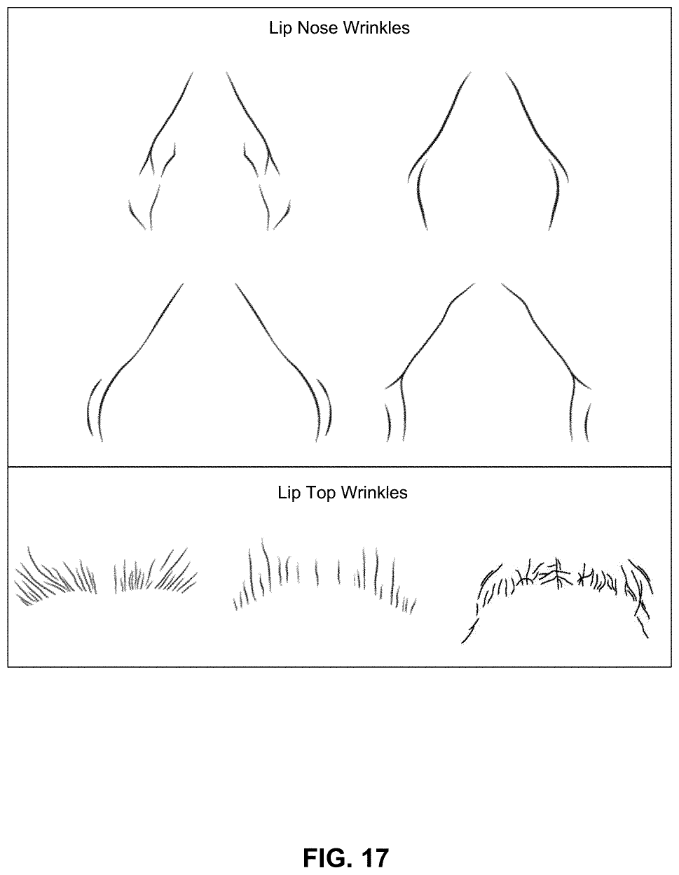

FIG. 15-FIG. 17 illustrates wrinkle objects available to the interactive makeup tutorial system 100, in accordance to an embodiment. These wrinkle objects may include digital images, formatted in PNG, JPEG, GIF, BMP, TIFF, or any other types of digital image format, including but not limited to cheek wrinkles, lip corner wrinkles, and double-chin wrinkles (shown in FIG. 15), eye wrinkles, eyebrow wrinkles, and forehead wrinkles (shown in FIG. 16), and lip nose wrinkles and lip top wrinkles (shown in FIG. 17). Images of these wrinkle objects may be stored in a database either locally on the computer device 10 or on a remote server and accessed and loaded into the face object container 103 by the face building app during the face building phase. Advantageously, the wrinkles objects expands the use of this system by providing textures and facial line elements that apply to an older age group of people, making it easy, applicable, and accessible for the elderly who are eager to learn the art of makeup and application thereof.

In practice, the face building phase is an interactive training process where the user is taught to build a face that best matches their own facial features by selecting face shapes, facial features objects, and wrinkle objects having the same or similar facial features they possess. In addition, the face building phase provides the user an interactive training aid teaching the user on how to build a visual representation and close resemblance of their face through visual feedback, visual comparison, and visual assessment based on the final face.

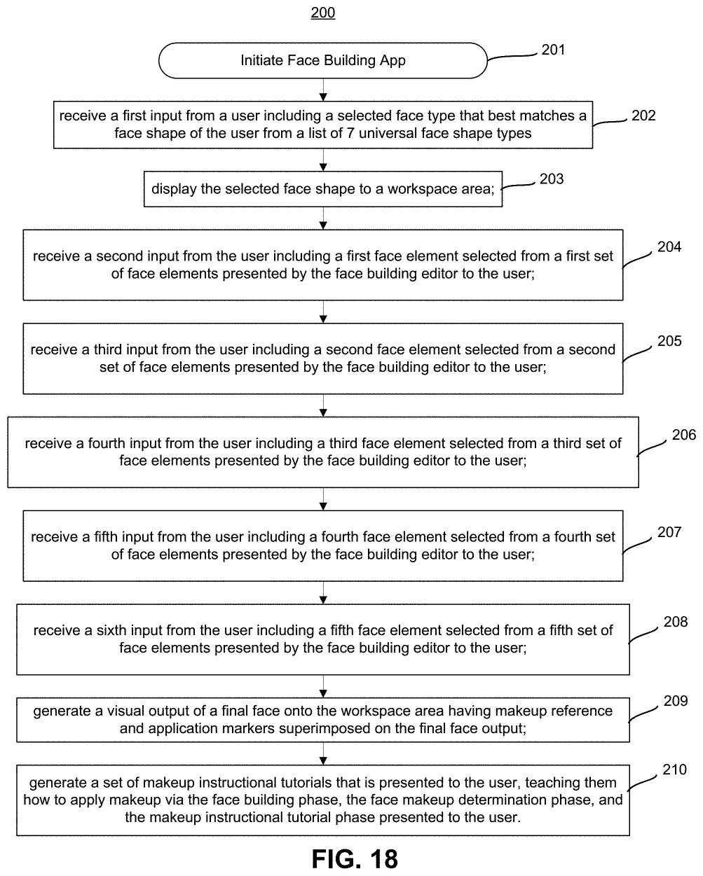

FIG. 18 illustrates a makeup tutorial flowchart 200 of the interactive makeup tutorial system 100, in accordance to an embodiment. The makeup tutorial flowchart 200 includes multiple of process steps executed by the processor 10-3 of the computing device 10 whereby the user is instructed to follow in the interactive makeup tutorial system 100. For example, the processor 10-3 may execute instructions to:
1) initiate the face building editor; (step 201)
2) receive a first input from a user including a selected face object that best matches a face shape of the user from a list of at least 7 face shape types (step 202), including but not limited to:
   i. round
   ii. square
   iii. oval
   iv. heart
   v. inverted triangle
   vi. oblong
   vii. triangle
3) display the selected face shape to a workspace area; (step 203)
4) receive a second input from the user including a first face element selected from a first set of face elements presented by the face building editor to the user; For example, the first set of face elements may include eyes. (step 204)
5) receive a third input from the user including a second face element selected from a second set of face elements presented by the face building editor to the user; For example, the second set of face elements may include noses. (step 205)
6) receive a fourth input from the user including a third face element selected from a third set of face elements presented by the face building editor to the user; For example, the third set of face elements may include lips. (step 206)
7) receive a fifth input from the user including a fourth face element selected from a fourth set of face elements presented by the face building editor to the user; For example, the fourth set of face elements may include eyebrows. (step 207)
8) receive a sixth input from the user including a fifth face element selected from a fifth set of face elements presented by the face building editor to the user; For example, the fifth set of face elements may include wrinkles. (step 208)
9) generate a visual output of a rendered face onto the workspace area having makeup reference and application markers superimposed on the final face output; (step 209) and
10) generate a set of makeup instructional tutorials that is presented to the user, teaching them how to apply makeup via the face building phase, the face makeup determination phase, and the makeup instructional tutorial phase presented to the user. These instructions provide written directions on how and where to apply makeup to different face elements. The degree and intensity of color make; circles are light, squares are medium, x's are dark. (step 210)

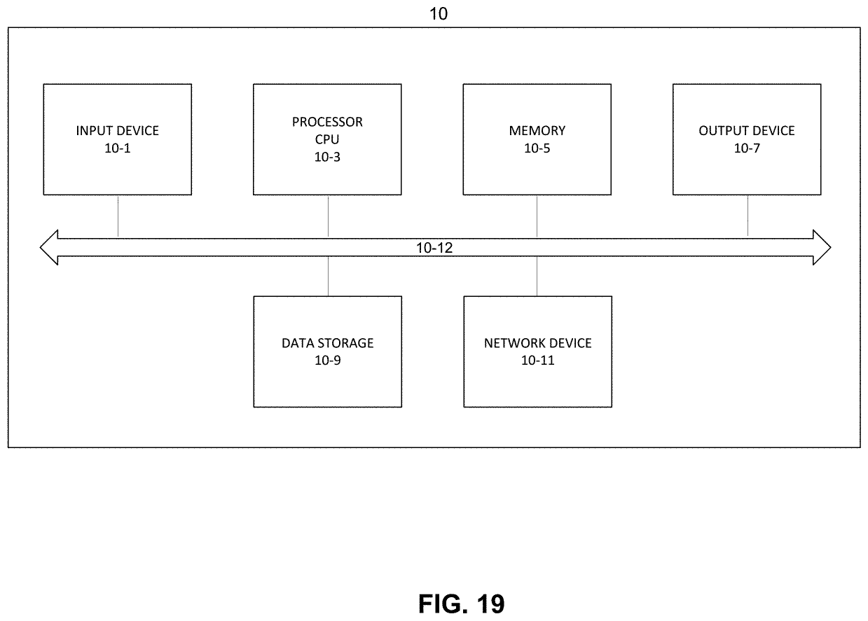

FIG. 19 illustrates a computing block diagram of the computing device 10 in which the interactive makeup tutorial system 100 operates and executes instructions therein, in accordance to an embodiment. For example, the computing device may include but is not limited to an input device 10-1, a processor or CPU 10-3, primary memory (RAM or ROM) 10-5, output device 10-7, data storage device 10-9, and network device 10-11, all interconnected, communicating, and transferring data via a communication data bus 10-12. In addition, these devices include one or more devices of the same type operating within the computing device 10. In one implementation, the input device 10-1 includes a touchscreen display capable of receiving inputs by the user via a capacitive touch screen which allows the input device 10-1 to receive and respond to input signal via electrical properties from the human body (i.e., finger input). The memory 10-5 may store executable instructions and algorithm for the processor 10-3 to execute instructions and commands from the interactive makeup tutorial system 100. The output device 10-3 may include at least a display screen for visually displaying graphical and textual information to the user. In one implementation, the instructions and commands from the interactive makeup tutorial system 100 may be stored locally in the data storage device 10-9 which may include, for example, flash memory devices or removable flash memory devices. In yet another implementation, the instructions and commands from the interactive makeup tutorial system 100 may be stored remotely on a remote server and communicated to the computing device 10 via the network device 10-11, including wireless networking devices.

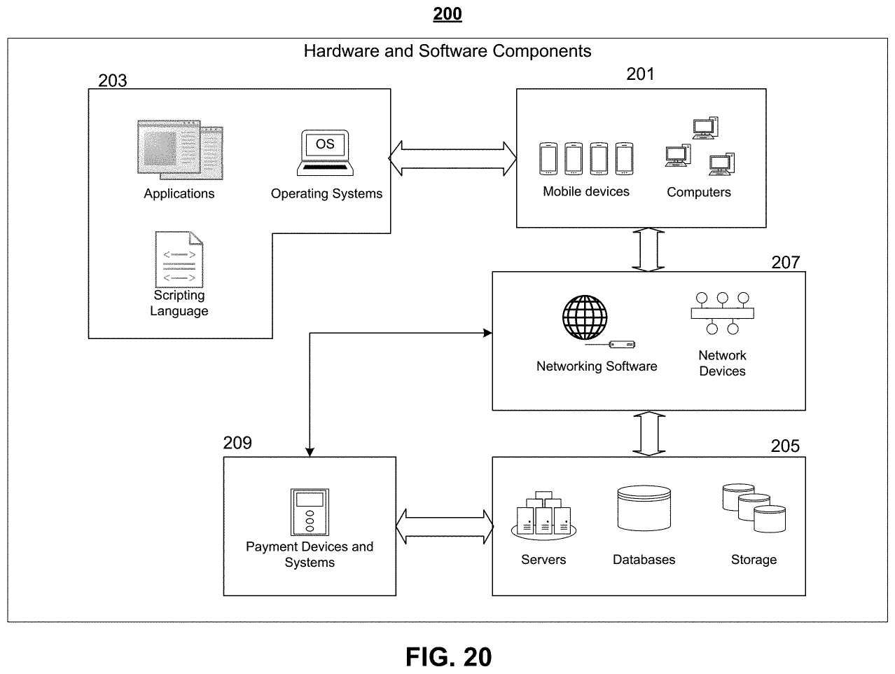

FIG. 20 illustrates system block architecture 200 of the interactive makeup tutorial system 100, in accordance to an embodiment. The system block architecture 200 may include both hardware and software components to facilitate the operation and functionality of the interactive makeup tutorial system 100 across a myriad of user device and systems, including but not limited to 1) mobile and computer devices 201 that are configured to host and manage the interactive makeup tutorial system 100; 2) software applications, scripting languages, and operating systems (OS) 203 for managing computer hardware, software resources, and providing common services for computer programs such as, for example, the face editor app, face makeup algorithm, and makeup instructions; 3) data storage facilities, servers, databases, and storage devices 205 for remotely storing object data utilized by the face building app, including but not limited to face components, facial element images, and makeup instructions; and 4) networking software and hardware components 207 for communicating and exchanging data between the mobile communicating devices 201 and the data storage devices 205. In another implementation, the system block architecture 200 may support payment devices and payment systems 209 as a means for collecting payment in order to access or install the interactive makeup tutorial system 100 on the user's mobile device 10. In one example, the mobile operating system may include mobile OS's such as iOS and Android OS. In another example, the backend database managing face objects, images, makeup instructions, and other makeup related content may include but is not limited to MySQL, Oracle, PostgreSQL, Microsoft SQL Server, and MongoDB. In yet another example, general-purpose scripting languages for program development may include but is not limited to PHP, Perl, Python, or JavaScript.

Other implementations of the interactive makeup tutorial system 100 may include but is not limited to providing the user a selection of face shapes and face elements by ethnicity, having a multilingual user interface, supporting real-time updates to face shapes, face objects, wrinkle objects, and makeup instructions,

Although examples of the input device described hereinabove is that of a touchscreen device for receiving one or more inputs via finger gestures, the interactive makeup tutorial system 100 may receive user inputs from other devices such as but not limited to a mouse, a pen stylus, or a keyboard.

In sum, advantageous features of interactive makeup tutorial system 100 include the face editor in the face building phase, the face makeup determination phase executed by computing device 10, and the makeup instructional tutorial phase generated by the computing device 10. In other implementations, the face editor can select a face shape based on ethnicity of the user. In another embodiment, the face editor can support user customization of face elements, allowing the option to upload custom eyebrows, eyes, noses, and lips based on their original shapes of face elements.

As used in the specification and the appended claims, the singular forms “a”, “an”, and “the” included plural referents unless the context clearly dictates otherwise.

The foregoing disclosure has been provided merely for the purpose of explanation and is in no way to be construed as limiting of the present disclosure. Although the present disclosure has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present disclosure in its aspects.

Other embodiments and modifications of the present disclosure may occur to those of ordinary skill in the art in view of these teachings. Accordingly, the disclosure is to be limited only by the following claims which include all other such embodiments and modifications when viewed in conjunction with the above specifications and accompanying drawings.

What is claimed is:

1. An interactive makeup tutorial system comprising: a processor that executes instructions to:
initiate a face building editor having a workspace area, a face object container, and control buttons at a face building phase;
receive a first input from a user, wherein the first input comprises a face object selected by the user from a plurality of face shape objects disposed in the face object container, wherein the face object matches a face shape of the user;
display the face object to the workspace area of the face building editor;
receive a second input from the user including a first face element selected from a first set of face elements presented by the face building editor to the user;
receive a third input from the user including a second face element selected from a second set of face elements presented by the face building editor to the user;
receive a fourth input from the user including a third face element selected from a third set of face elements presented by the face building editor to the user;
receive a fifth input from the user including a fourth face element selected from a fourth set of face elements presented by the face building editor to the user;
receive a sixth input from the user including a fifth face element selected from a fifth set of face elements presented by the face building editor to the user;
generate a visual output onto the workspace area at a face makeup determination phase, wherein the visual output comprises a rendered face object having a plurality of makeup reference markers superimposed thereon; and
generate a set of makeup instructional tutorials that are presented to the user at a makeup instructional tutorial phase.

2. The interactive makeup tutorial system of claim 1, wherein the plurality of face shape objects comprises a round shaped face, a square shaped face, an oval shaped face, a heart shaped face, an inverted triangle shaped face, an oblong shaped face, and a triangle shaped face.

3. The interactive makeup tutorial system of claim 1, wherein the first set of face elements comprises a plurality of eyes.

4. The interactive makeup tutorial system of claim 1, wherein the second set of face elements comprises a plurality of eyebrows.

5. The interactive makeup tutorial system of claim 1, wherein the third set of face elements comprises a plurality of noses.

6. The interactive makeup tutorial system of claim 1, wherein the fourth set of face elements comprises a plurality of lips.

7. The interactive makeup tutorial method of claim 1, wherein the fifth set of face elements comprises a plurality of wrinkles.

8. A interactive makeup tutorial method comprising:
initiating a face building editor having a workspace area, a face object container, and control buttons at a face building phase;
receiving a first input from a user, wherein the first input comprises a face object selected by the user from a plurality of face shape objects disposed in the face object container, wherein the face object matches a face shape of the user;
displaying the face object to the workspace area of the face building editor;
receiving a second input from the user including a first face element selected from a first set of face elements presented by the face building editor to the user;
receiving a third input from the user including a second face element selected from a second set of face elements presented by the face building editor to the user;
receiving a fourth input from the user including a third face element selected from a third set of face elements presented by the face building editor to the user;
receiving a fifth input from the user including a fourth face element selected from a fourth set of face elements presented by the face building editor to the user;
receiving a sixth input from the user including a fifth face element selected from a fifth set of face elements presented by the face building editor to the user;
generating a visual output onto the workspace area at a face makeup determination phase, wherein the visual output comprises a rendered face object having a plurality of makeup reference markers superimposed thereon; and
generating a set of makeup instructional tutorials that are presented to the user at a makeup instructional tutorial phase.

9. The interactive makeup tutorial method of claim 8, wherein the plurality of face shape objects comprises a round shaped face, a square shaped face, an oval shaped face, a heart shaped face, an inverted triangle shaped face, an oblong shaped face, and a triangle shaped face.

10. The interactive makeup tutorial method of claim 8, wherein the first set of face elements comprises a plurality of eyes.

11. The interactive makeup tutorial method of claim 8, wherein the second set of face elements comprises a plurality of eyebrows.

12. The interactive makeup tutorial method of claim 8, wherein the third set of face elements comprises a plurality of noses.

13. The interactive makeup tutorial method of claim 8, wherein the fourth set of face elements comprises a plurality of lips.

14. The interactive makeup tutorial method of claim 8, wherein the fifth set of face elements comprises a plurality of wrinkles.

15. A non-transitory computer-readable storage medium with an executable computer program that causes a computer processor to execute processing, comprising:
initiating a face building editor having a workspace area, a face object container, and control buttons at a face building phase;
receiving a first input from a user, wherein the first input comprises a face object selected by the user from a plurality of face shape objects disposed in the face object container, wherein the face object matches a face shape of the user;
displaying the face object to the workspace area of the face building editor;
receiving a second input from the user including a first face element selected from a first set of face elements presented by the face building editor to the user;
receiving a third input from the user including a second face element selected from a second set of face elements presented by the face building editor to the user;
receiving a fourth input from the user including a third face element selected from a third set of face elements presented by the face building editor to the user;
receiving a fifth input from the user including a fourth face element selected from a fourth set of face elements presented by the face building editor to the user;
receiving a sixth input from the user including a fifth face element selected from a fifth set of face elements presented by the face building editor to the user;
generating a visual output onto the workspace area at a face makeup determination phase, wherein the visual output comprises a rendered face object having a plurality of makeup reference markers superimposed thereon; and
generating a set of makeup instructional tutorials that are presented to the user at a makeup instructional tutorial phase.

16. The non-transitory computer-readable storage medium of claim 15, wherein the plurality of face shape objects comprises a round shaped face, a square shaped face, an oval shaped face, a heart shaped face, an inverted triangle shaped face, an oblong shaped face, and a triangle shaped face.

17. The non-transitory computer-readable storage medium of claim 15, wherein the first set of face elements comprises a plurality of eyes.

18. The non-transitory computer-readable storage medium of claim 15, wherein the second set of face elements comprises a plurality of eyebrows.

19. The non-transitory computer-readable storage medium of claim 15, wherein the third set of face elements comprises a plurality of noses.

20. The non-transitory computer-readable storage medium of claim 15, wherein the fourth set of face elements comprises a plurality of lips, and the fifth set of face elements comprises a plurality of wrinkles.
